(19) United States
(12) Patent Application Publication
(10) Pub. No.: US 2026/0227530 A1
(43) Pub. Date: Aug. 6, 2026

(54) METHOD AND ASSEMBLY FOR CHARACTERIZING A SOLID SAMPLE LIKELY TO CONTAIN A RADIOACTIVE ELEMENT DISINTEGRATING ACCORDING TO A DISINTEGRATION CHAIN BY EMISSION OF A AND/OR B PARTICLES

(71) Applicants: Orano Mining, CHATILLON (FR); AI4R, NANTES (FR); Centre national de la recherche scientifique, PARIS (FR); UNIVERSITE DE POITIERS, POITIERS CEDEX (FR)

(72) Inventors: Jérôme DONNARD, NANTES (FR); Paul SARDINI, BONNEUIL-MATOURS (FR); Michaël DESCOSTES, PARIS (FR)

(21) Appl. No.: 19/152,161

(22) PCT Filed: Jan. 30, 2024
(86) PCT No.: PCT/EP2024/052254

§ 371 Date: Jul. 30, 2025

(30) Foreign Application Priority Data
Jan. 31, 2023 (FR) FR2300887

(51) Int. Cl. G01T 1/167; G01T 1/30

(52) U.S. Cl. CPC G01T 1/167; G01T 1/30

(57) ABSTRACT

A method and assembly for characterizing a solid sample containing a radioactive element disintegrating, the method including the following steps: Taking an autoradiograph of the solid sample including recording the following data for each detected a or p particle: time of detection of the particle, the spatial coordinates of an emergence point of the particle and the charge deposited by the particle upon detection and analyzing the recorded data to detect two successive isotopes in the disintegration chain with the following sub-steps. Locating pairs of particles verifying the following criteria: the detection times separated by a time interval; the distance between the respective emergence points; and the charge deposited by the detected first particle corresponding to the disintegration of the first isotope; and the charge deposited by the detected second particle of the second isotope; and counting the number of pairs identified.

### CROSS-REFERENCE TO RELATED APPLICATIONS

This application is the U.S. National Phase of PCT Appl. No. PCT/EP2024/052254 filed Jan. 30, 2024, which claims priority to FR 23 00887, filed Jan. 31, 2023, the entire disclosures of which are incorporated by reference herein.

### TECHNICAL FIELD

The present disclosure generally relates to a method for characterizing a solid sample that may comprise a radioactive element decaying through a decay chain by the emission of α and/or β particles.

### BACKGROUND

The article by Morishita et al. “Development of an α- and β-imaging detector using a thin-stilbene plate for radon-222 progeny measurements,” 2021, Radiation measurements, discloses a detector that facilitates the identification of areas in a sample where the progeny of ²²²Rn are located. This detector is not very precise when the isotopes to be measured are in trace form, making it impossible to establish a large-scale and high-precision mapping of the samples.

### SUMMARY

In this context, the present disclosure aims to propose a characterization method that does not have the above disadvantage.

To that end, the present disclosure comprises a method for characterizing a solid sample that may comprise a radioactive element decaying through a decay chain by the emission of α and/or β particles, the decay chain successively passing through a first radioactive isotope and then a second radioactive isotope, the first isotope decaying by the emission of a first particle of type α or type β with a first half-life period, the second isotope decaying by the emission of a second particle of type α or type β with a second half-life period shorter than the first half-life period, the method comprising the following steps:

Autoradiography of the solid sample with detection using a detector of the α and/or β particles emitted by the solid sample, and for each α or β particle detected, recording the following data: the detection time of the particle, the spatial coordinates of a point of emergence of the particle and the charge deposited by the particle upon detection;

Analysis of the recorded data to detect the presence of the first and/or second radioactive isotope(s) in the solid sample, the data analysis comprising the following sub-steps:
Identifying pairs comprising a first detected particle and a second detected particle later than the first, said pair meeting the following criteria: respective detection times of the first detected particle and the second detected particle separated by a time interval that is less than a given pair's time limit; the distance between the respective points of emergence of the first detected particle and the second detected particle less than a given pair spatial limit; and the charge deposited by the first detected particle corresponding to the type of the first particle emitted by the first isotope during its decay; and the charge deposited by the second detected particle corresponding to the type of second particle emitted by the second isotope during its decay;
Counting the number of identified pairs.

By using multiple simultaneous criteria for data analysis, it is possible to detect the presence of traces of the first and/or second radioactive isotope(s) s in the solid sample. The method indeed relies on identifying pairs of particles whose detection times are very close to one another, and whose points of emergence are corresponding.

This allows inferring with a high probability of certainty that these two particles correspond to the successive decay of the first and second isotope, and thus conclude that the progeny of the sought radioactive element are present in the solid sample.

The analysis of the charges emitted by the first and second detected particles confirms that the detected particles indeed correspond to the types of particles emitted by the decay of the first and second isotopes.

At the end of the counting, it is possible to establish a mapping of the solid sample, allowing to appreciate the distribution of the first and second isotopes in this sample.

The method may also comprise one or more of the following features, considered individually or in all technically possible combinations:
The respective detection times of the first and second detected particles of the same pair are immediately consecutive with no other particle being detected between the first and second detected particles;
The decay chain successively passes through a plurality of radioactive isotopes, each decaying by the emission of a particle of type α or type β with a half-life period, the second half-life period being the smallest of the group of half-life periods in the decay chain greater than a dead time of the detector;
Said time interval is less than 20 times the second half-life period;
The data-analysis step further comprises a sub-step of mapping in the solid sample the spatial coordinates of the points of emergence of the first and second detected particles of the identified pairs;
The decay chain passes through a third radioactive isotope immediately before the first radioactive isotope, the third isotope decaying by the emission of a third particle of type α or type β, the data-analysis step comprising a sub-step of searching, for each identified pair, for a third detected particle that meets the following criteria: the detection time of the third detected particle is earlier than the detection time of the first detected particle and separated from it by a time interval that is less than a given triplet time limit; the distance between the respective points of emergence of the third detected particle and the first detected particle less than a given triplet spatial limit; and the charge deposited by the third detected particle corresponding to the type of the third particle emitted by the third isotope during its decay;
The decay chain is chosen from:
That of ²³⁵U, the first isotope being ²¹⁹Rn and the second being ²¹⁵Po; or
That of ²³⁸U, the first isotope being ²¹⁴Bi and the second being ²¹⁴Po; or
That of ²³²Th, the first isotope being ²²⁰Rn and the second being ²¹⁶Po; or
That of ²³⁷Np, the first isotope being ²²¹Fr and the second being ²¹⁷At.

According to a second aspect, the present disclosure comprises a characterization set of a solid sample that may comprise a radioactive element decaying through a decay chain by the emission of α and/or β particles, the decay chain successively passing through a first radioactive isotope and then a second radioactive isotope, the first isotope decaying by the emission of a first particle of type α or type β with a first half-life period, the second isotope decaying by the emission of a second particle of type α or type β with a second half-life period shorter than the first half-life period, the characterization set comprising: An autoradiography system of the solid sample comprising a detector configured to detect the α and/or β particles emitted by the solid sample, and, for each α or β particle detected, record the following data: the detection time of the particle, the spatial coordinates of a point of emergence of the particle and the charge deposited by the particle upon detection;
A unit for analyzing the recorded data, being configured to identify the presence of the first and/or second radioactive isotope(s) in the solid sample, the data analysis unit being configured to:
Identify the pairs that comprise a first detected particle and a second detected particle later than the first, said pair meeting the following criteria: respective detection times of the first detected particle and the second detected particle separated by a time interval that is less than a given pair's time limit; the distance between the respective points of emergence of the first detected particle and the second detected particle less than a given pair spatial limit; and the charge deposited by the first detected particle corresponding to the type of the first particle emitted by the first isotope during its decay; and the charge deposited by the second detected particle corresponding to the type of second particle emitted by the second isotope during its decay;
Counting the number of identified pairs.

The characterization set may further be such that:
The data analysis unit is configured to map, in the solid sample, the spatial coordinates of the emergence points of the first and second detected particles of the identified pairs;
The decay chain passes through a third radioactive isotope immediately before the first radioactive isotope, the third isotope decaying by the emission of a third particle of type α or type β, the data analysis unit being configured to search, for each identified pair, for a third detected particle that meets the following criteria:

The detection time of the third detected particle is earlier than the detection time of the first detected particle and separated from it by a time interval that is less than a given triplet time limit;

The distance between the respective emergence points of the third detected particle and the first detected particle less than a given triplet spatial limit;

The charge deposited by the third detected particle corresponding to the type of the third particle emitted by the third isotope during its decay.

### BRIEF DESCRIPTION OF DRAWINGS

Other features and advantages of the present disclosure will emerge from the detailed description given below, as an indication and in no way limiting with reference to the appended figures, among which:

FIG. 1 represents the decay chains of ²³⁵U and ²³⁸U;

FIG. 2 is a simplified schematic representation of the characterization set of the present disclosure;

FIG. 3 is a schematic representation of the data structure recorded by the autoradiography system of FIG. 2;

The FIGS. 4 and 5 are graphs that indicate, for a sample of uranium ore, the number of particles detected as a function of the amplitude of the measured signal, when the autoradiography system operates in α mode (FIG. 4) and when it operates in the electron mode (FIG. 5);

FIG. 6 is a graph that shows, for pairs of particles detected nearly simultaneously and at the same position, the two-dimensional histogram of the amplitude of the signal generated by the first detected particle, and the amplitude of the signal generated by the second detected particle, the data acquired with the autoradiography system in the electron mode;

FIG. 7 is a graph that shows the distribution of distance between the respective emergence points of the α particle pairs that are emitted nearly simultaneously within an 18-millisecond time window, for a sample of uranium ore at secular equilibrium, the data acquired with the autoradiography system in a mode;

FIG. 8 is a graph that shows the distribution of time intervals separating the respective detection times of successive a particle pairs, for the same data as shown in FIG. 7;

FIG. 9 is a graph similar to FIG. 8, limited to particles whose emergence points are almost coincident;

FIG. 10, a view similar to that of FIG. 9, shows the distribution of detection-time intervals of the first and second particles of the same pair, for another application wherein the first particle corresponds to the decay of ²¹⁴Bi and the second particle to the decay of ²¹⁴Po;

FIG. 11 is a schematic representation of a variant of the method, intended to detect three successive decays (²²³Ra, ²¹⁹Rn and ²¹⁵Po), and not just two successive decays; and

FIG. 12 is a graph similar to FIG. 8, illustrating the distribution of detection-time intervals between the third particle and the first particle in the embodiment variant of FIG. 11.

### DETAILED DESCRIPTION

The present disclosure relates to a method and a characterization set of a solid sample likely to contain a radioactive element decaying through a decay chain by the emission of α and/or β particles.

The solid sample is typically a geological sample, for example, uranium ore. Alternatively, this sample is residue or mining waste from, for example, a uranium mine, or a natural material such as granite likely to contain radon or any other natural or artificial material likely to contain such a decay chain having a short half-life element.

The radioactive element contained in the solid sample is a radioisotope from a radioactive decay chain comprising at least three elements.

The radioactive element contained in the solid sample is, for example, from the decay chain of uranium 235, uranium 238, thorium 232, neptunium 237 or, more generally, any natural or artificial actinide.

Alternatively, the radioactive element is a descendant of one of the aforementioned elements.

The present disclosure also applies in the medical field, particularly in nuclear medicine. In such applications, radioactive elements are injected into the patient's body for therapy or imaging purposes.

In this case the solid sample is the patient's body or a sample taken from the patient's body. The sample is, for example, a tissue sample from a patient or a study animal.

In this case the radioactive element contained in the solid sample is, for example, ²²⁵Ac, ²²³Ra, ²²⁷Th or ²¹³Bi.

The decay chain successively passes through a plurality of radioactive isotopes, each decaying by the emission of a particle of type α or type β with a given half-life period.

The α particle consists of two protons and two neutrons combined, thus forming a particle identical to the helium-4 nucleus.

The β particle is typically an electron.

The decay chain stops when the last radioactive isotope, through its decay, leads to the formation of a stable element.

The decay chain can often be at secular equilibrium. At secular equilibrium, within the decay chain, the number of decays per unit of time of all the radioactive isotopes of the chain is substantially the same.

The radioactive elements of a decay chain are at secular equilibrium if the considered system is closed for a duration equal to 10 times the longest half-life of these elements, except for the first element in the chain.

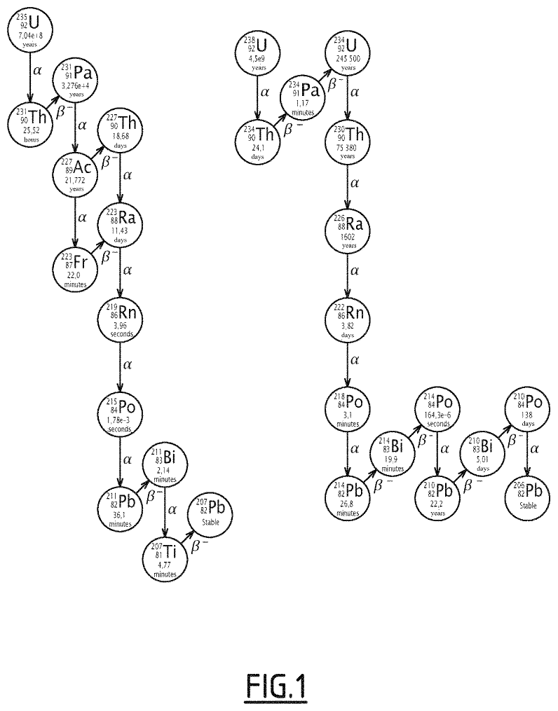

FIG. 1 represents the decay chains of ²³⁵U and ²³⁸U. The half-life periods of the radioactive isotopes of the decay chain range from several million years to a few microseconds.

The present detection method takes advantage of decays with very short half-life periods, which are typically less than one second. When a first isotope generates by decay a second isotope with a very short half-life period, the decay of this second isotope immediately follows the decay of the first isotope. This sequence results in the emission of two particles at times that are very close to one another, said particles that originate from the same area of the solid sample.

In the decay chain of ²³⁵U, ²¹⁵Po decays by the emission of an α particle with a half-life period of 1.78 milliseconds. Thus, the decay of ²¹⁹Rn by the emission of an α particle is immediately followed by the decay of ²¹⁵Po by the emission of an α particle.

In the decay chain of ²³⁸U, ²¹⁴Po decays by the emission of an α particle with a half-life period of 164 microseconds. Thus, the decay of ²¹⁴Bi by the emission of a β⁻ particle is immediately followed by the decay of ²¹⁴Po by the emission of an α particle.

Thus, in the characterization method of the present disclosure, a decay chain is considered passing successively through a first radioactive isotope and then a second radioactive isotope, the first isotope decaying by the emission of a first particle of type α or type β with a first half-life period, the second isotope decaying by the emission of a second particle of type α or type β with a second half-life period shorter than the first half-life period.

The method aims to detect the presence of the first and/or second radioactive isotope(s) in the solid sample.

Typically, the second half-life period is the smallest of the group of half-life periods in the decay chain greater than the dead time of the detector.

The dead time of the detector is the time interval that must at least separate two events for the detector to distinguish them from one another.

Generally, the second half-life period is the smallest of the group of half-life periods in the decay chain.

It is typically less than one second, preferably less than 100 milliseconds and even more preferably less than 10 milliseconds.

The characterization method comprises an autoradiography step of the solid sample with detection of the α and/or β particles emitted by the solid sample.

Autoradiography is a technique of radiography of the solid sample without an external source of radiation.

For each detected α or β particle, the following data is recorded: the detection time of the particle, the spatial coordinates of the emergence point of the particle and the charge deposited by the particle upon detection.

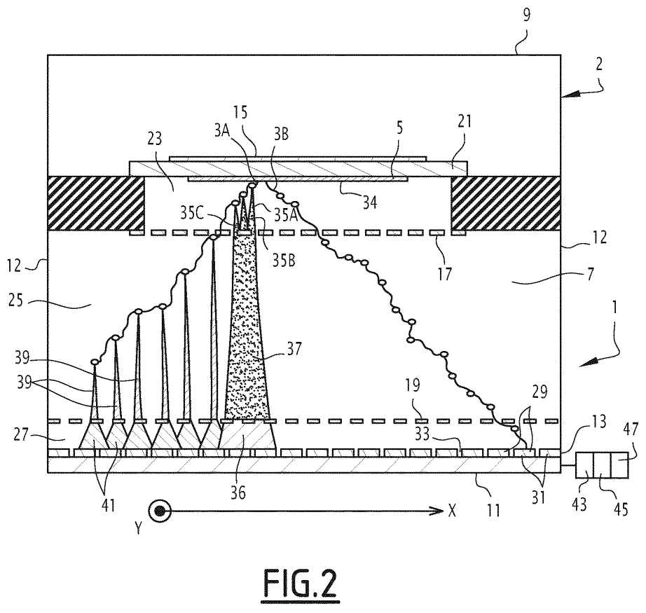

The autoradiography step is performed, for example, in the autoradiography system 1 represented in FIG. 2. Such a system is sold under the name Beaquant by the company Ai4R (Nantes). It is described in patent application FR3075980.

The autoradiography system 1 comprises a detector 2, which is adapted to detect the α or β type particles 3A and 3B that are emitted by the solid sample 5.

The detector 2 is substantially similar to the gaseous detector described in document WO 2011/039473 A1.

The detector 2 comprises a chamber 7, which is defined by two main walls 9, 11 opposite and parallel to one another, and the side walls 12.

The main walls 9, 11 have, for example, a surface area that ranges from 1 cm×1 cm to 30 cm×30 cm.

The chamber 7 contains a detection medium that is adapted to emit primary electrons under the effect of the α radiation emitted by the sample 5.

The detection medium is typically composed of a gaseous mixture circulating in the chamber 7 between an inlet and an outlet (not shown).

The gaseous mixture is, for example, a mixture between a rare gas, for example, xenon, and a polyatomic gas, for example, CH₄.

The gaseous mixture is advantageously at a pressure of 0.1 bar to 5 bars, for example, 1 bar.

The detector 2 comprises an anode 13, a cathode 15, a first electrode 17 and a second electrode 19.

Typically, the anode 13, the cathode 15, the first electrode 17 and the second electrode 19 are parallel to one another and parallel to the two main walls 9, 11 of the chamber 7.

The cathode 15 is, for example, a conductive adhesive, for example, a copper adhesive, that is adhered to one side of a glass slide 21, the sample 5 being placed on the opposite side of the glass slide 21.

The cathode 15 and the first electrode 17 together constitute a first amplification space 23.

The first electrode 17 and the second electrode 19 together constitute a drift space 25.

The second electrode 19 and the anode 13 together constitute a second amplification space 27.

The amplification and drift phenomena are described in the following description.

The first electrode 17 and the second electrode 19 are, for example, MICROMEGAS type microgrids as described in WO 2011/039473 A1.

Advantageously, the means of polarization (not shown) is connected to the cathode 15, the anode 13, the first electrode 17 and the second electrode 19. This allows the cathode 15 to be at a potential V₁, the anode 13 at a potential V₂, the first electrode 17 at a potential V₃ and the second electrode 19 at a potential V₄.

Typically, these potentials satisfy the relationship V₂>V₄>V₃>V₁.

The polarization means thus allow creating electric fields E₁, E₂, E₃ respectively in the first amplification space 23, the drift space 25 and the second amplification space 27.

The electric fields E₁ and E₃ in the first amplification space 23 and the second amplification space 27 are typically greater than 3 kV/cm.

The electric field E₂ in the drift space 25 is, for example, less than 3 kV/cm.

The potentials V₁, V₂, V₃ and V₄ are advantageously less than α few kV, for example, 3 kV.

The detector 2 comprises a plurality of measurement cells 29 adapted to measure at least one incident signal generated by an interaction of the particles 3A and 3B with the detection medium of the detector 2.

In the case of the gaseous detector 2 described above, the measurement cells 29 are formed by elementary anodes or pads 31 of the anode 13.

The anode 13 is, for example, of the type described in document WO 2011/039473 A1.

The pads 31 are typically separated from one another by spaces 33 and form a two-dimensional checkerboard measurement network whose rows are aligned along perpendicular X and Y coordinate axes.

Each pad 31 forms, for example, a square of less than one millimeter on a side, for example, 650 μm. The pads 31 are alternately assigned to the reading of either of the X and Y coordinates. Two neighboring pads 31 do not measure the same position according to the same coordinate. The space 33 between the pads 31 is as small as possible but still allows each pad 31 to be isolated from the neighboring pad 31. For example, the space 33 is less than or equal to 100 μm.

The structure of each pad 31 is, for example, similar to that described in document WO 2011/039473 A1.

The signal measured by the pads 31 is typically an incidental electric charge.

The pads 31 allow converting an incidental electric charge into an electrical current proportional to said charge.

The measured electrical current is processed in the electronics 43 of the detector 2.

The data is recorded in a digital processing unit 45 of the autoradiography system 1, for example, a computer memory.

This unit 45 is digitally connected to the processing electronics 43 of the detector 2.

The solid sample 5 is typically a thin layer with a thickness of 5 μm to 100 μm, for example, 20 μm.

The sample 5 has, for example, lateral dimensions advantageously smaller than the field of view of the detector 2, i.e., the dimensions of the anode 13.

The field of view of the detector 2 corresponds to the solid angle through which the detector 2 is sensitive to the radiation of the particles 3A and 3B.

The sample 5 is typically deposited on the glass slide 21 in order to keep the sample substantially parallel to the anode 13.

The glass slide 21 typically has a thickness of one millimeter.

Alternatively, the sample 5 is deposited on a piece of metal.

Advantageously, the surface of the sample 5 is substantially smooth and substantially parallel to the electrode 17.

It has a large flat face 34, parallel to the anode 13 and facing the first amplification space 23.

Referring to FIG. 2, a particle 3A, 3B is emitted by the sample 5 at the level of the large flat face 34. The particle 3A, 3B crosses the chamber of the detector 2 and interacts with the gaseous medium by generating primary electrons that diffuse and multiply in the chamber 7 of the detector 2 from the cathode 15 to the anode 13.

This phenomenon allows determining the emergence position of the particle, using the measurement cells 29. The emergence position corresponds to the position of the first interaction of the particles 3A and 3B with the detection medium of the detector 2.

This position corresponds to the location of the radionuclide in the sample 5 that is the source of the emission of the particles 3A and 3B.

The electric field E₁ prevailing in the first amplification space 23 accelerates the electrons that are created by the interaction between the particles 3A, 3B and the gaseous medium. Each electron collides with a gas atom and ionizes it with the release of a new electron. The two electrons ionize two gas atoms again, each releasing an electron. Thus, due to the avalanche effect, more and more electrons are created between the cathode 15 and the first electrode 17.

As can be seen in FIG. 2, the particles 3A and 3B interact successively with several gas atoms in the first amplification space 23. Each of these interactions is amplified by the electric avalanche effect and contributes to the charge peak materialized by a trapezoid 36 in FIG. 2.

The electrons 35A, 35B and 35C generated by the electric avalanche phenomenon in the first amplification space 23 then diffuse into the drift space 25. The drift space 25 allows transferring the electric charges 39 and 37 to the anode 13.

A second amplification occurs in the second amplification space 27 by the electric avalanche effect, similar to what has been described above.

The entry position of the particles 3A and 3B in the amplification space 23 is typically determined using the pads 31, respectively assigned to the measurement along the X axis and along the Y axis, receiving the electric charge at the output of the amplification space 27.

The position of the first interaction of the particles 3A and 3B with the detection medium of the detector 2 is then determined from the distribution of the incident signals measured by the measurement cells 29, i.e., from the distribution of the incidental electric charges thus measured by the pads 31 of the anode 13. The retained position corresponds, for example, to the barycenter of the incidental electric charges thus measured.

The position thus determined corresponds to the emergence position of the particles 3A and 3B.

After crossing the first amplification space 23, the particles 3A and 3B continues its path in the drift space 25. The particles 3A and 3B then interact successively with atoms of the gaseous medium of the drift space and generates electrons 39 that diffuse in the drift space 25 to the second amplification space 27 where the electric charges 41 are amplified by an electric avalanche effect similar to what has been described previously and then detected by the pads 31 of the anode 13.

Some particles 3A and 3B continue their path in the second amplification space 27, where they generate electrons again, others being subjected to calorimetry in the gas and stopping within the chamber.

The detector 2 allows determining the charge deposited by the particles 3A and 3B within the detector 2 using the measured incident signal.

For this, the charges 41, 36 generated successively along a trajectory of the particles 3A and 3B within the detector 2 are measured.

The electric charges 41 and 36 are typically diffused in the drift space 25 and amplified in the two amplification spaces 23 and 27.

The measurements are made using the pads 31 of the anode.

The autoradiography system 1 thus allows for each detected particle to record the time at which the particle is emitted by the sample, to spatially locate each detected particle in the solid sample, and to discriminate between a particles and β particles on the basis of the deposited charge. The β particles typically deposit a much lower charge than the α particles within the autoradiography system.

The deposited charge is the energy transferred to the detection medium by the particle.

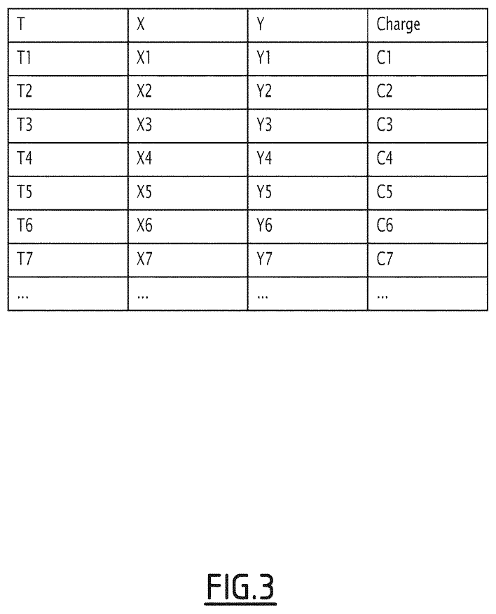

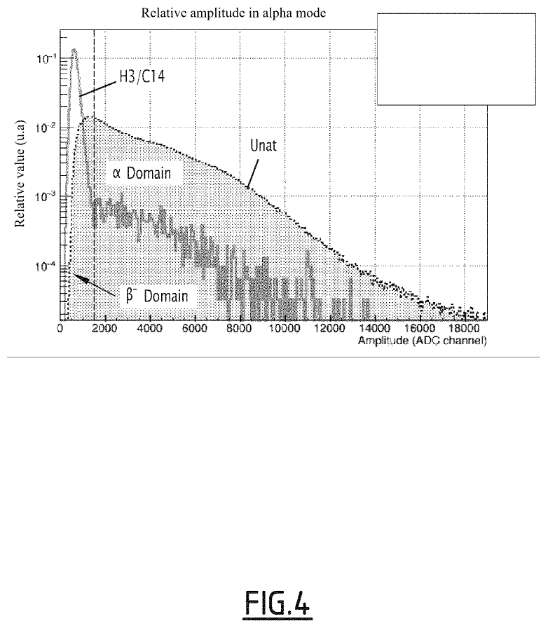

The recorded data, as illustrated in FIG. 3, are presented in the form of a table, each row of the table corresponding to a detected particle. Each row includes the time T at which the particle was detected, the spatial coordinates X and Y of the emergence point of the particle, and the charge C deposited by the particle in the detector 2 of the autoradiography system.

The dead time of the autoradiography system corresponds to the time interval separating the detection of a particle by the detector 2 and the recording of its signal by the electronics.

The dead time must be significantly lower than the half-life of the radioactive element emitting the second particle.

The data is sorted in chronological order, i.e., by increasing detection time. The origin of the times corresponds to the start of data acquisition. The detection time of the particle corresponds substantially to the emission time of the particle from the solid sample.

The method further includes a step of analyzing the recorded data to detect the presence of the first and/or second radioactive isotope(s) in the solid sample.

To do this, the data-analysis step comprises a sub-step of identifying pairs comprising a first detected particle and a second detected particle later than the first, each pair of particles meeting the following criteria:
respective detection times of the first detected particle and the second detected particle separated by a time interval that is less than a given pair's time limit;
The distance between the respective emergence points of the first detected particle and the second detected particle less than a given pair spatial limit;
The charge deposited by the first detected particle corresponding to the type of the first particle emitted by the first isotope during its decay;
The charge deposited by the second detected particle corresponding to the type of second particle emitted by the second isotope during its decay.

The sub-step of locating aims to identify in the recorded data all pairs of particles meeting the above criteria.

The given pair's time limit is chosen with reference to the half-life period of the second radioactive isotope. This pair time limit is chosen to be less than 20 times the second half-life period and is preferably equal to ten times the second half-life period.

The pair time limit can be chosen relatively smaller if the total activity of the solid sample is high.

The given pair's time limit is typically chosen small enough so that the respective detection times of the first and second detected particles of the same pair are immediately consecutive. In other words, the probability of another particle being detected between the first and second particles is low.

The given pair spatial limit is much smaller than the size of the sample, specifically that of the large face 34. It is typically on the order of 200 to 400 micrometers.

The data-analysis step also includes a sub-step of counting the number of identified pairs.

The counting sub-step, for example, provides the number of identified pairs for each point of the solid sample.

In other words, it provides the number of identified pairs emerging at each point of the sample.

The counting sub-step also allows for providing the total number of identified pairs.

Advantageously, the data-analysis step comprises a sub-step of mapping in the radiological sample the spatial coordinates of the emergence points of the first and second detected particles of the identified pairs.

This mapping provides for each point of the radiological sample the number of identified pairs emerging at said point. It is presented in a graphical form, but it may be tabulated or otherwise represented in any suitable form.

As mentioned above, the data related to the charge deposited by the detected particle in the autoradiography system allow discriminating between β− particles and a particles.

The autoradiography system can, for example, operate in two different modes, the α mode and the electron mode.

In electron mode, the signal generated at the anode 13 is processed with a high gain in the electronics 43 of the autoradiography system. Indeed, the charge deposited by the electrons is relatively low. The signal from the electron's path in the drift space 25 is practically indistinguishable from the background noise. Only the signal created in the first amplification space 23 is strong enough to stand out from the background noise.

Conversely, in a mode, the signal collected on the anode 13 is processed in the device's electronics with relatively lower gain. This is due to the fact that the charge deposited by the α particle is high and generates, at the anode 13, a signal clearly distinct from that of the background noise.

FIG. 4 illustrates the signal collected by the autoradiography system in a mode, for a sample of uranium ore at secular equilibrium. The abscissa corresponds to the amplitude of the signal, which in turn corresponds to the charge deposited in the detector 2 by the detected particle. The ordinate corresponds to the number of particles detected for each amplitude value, expressed in relative value.

The relative value is also called probability density function in English (acronym PDF in English). It corresponds to a normalized curve for which the integral is unitary.

The curve reaches a maximum for a low amplitude value and then gradually decreases from this maximum. The detected particles generating a low amplitude signal correspond to electrons. Conversely, the particles generating a high amplitude signal are α particles.

In the example shown, filtering the detected particles that generate a signal with an amplitude less than 2000 makes it possible to eliminate the detected particles of type β. This is clearly highlighted by the curve superimposed on that of the uranium-ore sample. This curve was collected under the same conditions, for a sample containing 3H and 14C. These isotopes are β emitters. The curve for these isotopes shows a peak under the amplitude 2000.

In the example shown, 65% of the signal corresponds to alpha particles and 35% of the signal corresponds to beta particles.

FIG. 5 illustrates the signal collected by the detector in the electron mode, for the same sample.

The abscissa corresponds to the amplitude of the collected signal and the ordinate to the number of particles detected for each amplitude, these being in relative values.

FIG. 5 shows, at high amplitudes, a significant bump, corresponding essentially to α particles. It shows in the low amplitude part another bump, corresponding to β particles.

Eliminating all particles with an amplitude greater than 15000, in the example shown, allows filtering α particles and retaining only β particles. In the example shown, 65% of the initial signal corresponds to alpha particles and 35% of the initial signal corresponds to beta particles.

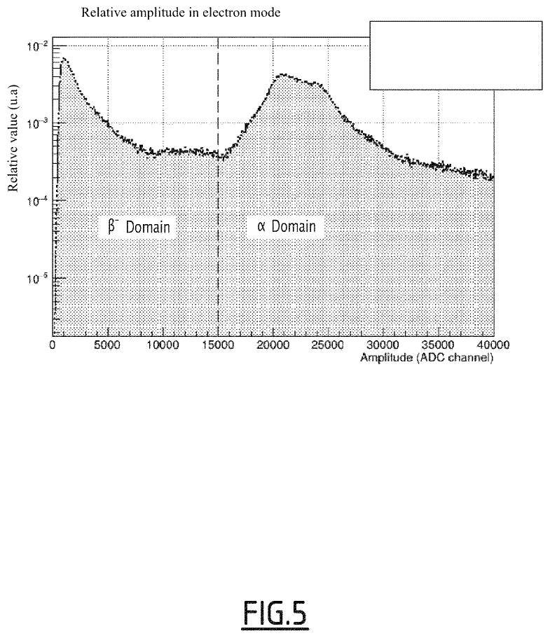

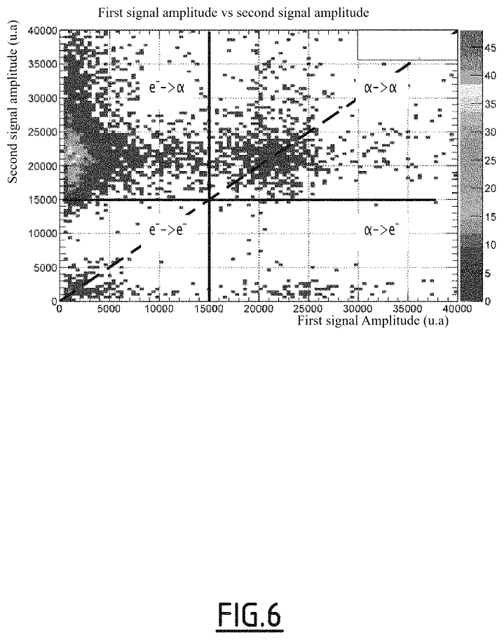

FIG. 6 shows that it is possible to recognize the types of particles on the basis of the amplitude of the collected signal, corresponding to the charge deposited in the autoradiography system.

The processed data were collected by the autoradiography system for a sample of uranium ore at secular equilibrium, in the electron mode. In FIG. 6, the abscissa corresponds to the amplitude of the signal generated by the first detected particle, and the ordinate corresponds to the amplitude of the signal generated by the second detected particle.

FIG. 6 represents the two-dimensional distribution of the amplitudes of the two detected particles. The shade of gray is a function of the number of detected particle pairs, according to the chart located to the right of the graph. The considered particle pairs meet the criterion on the interval between detection times and the criterion on the distance between emergence points. The criterion on the interval between detection times was 17.8 milliseconds. The criterion on the distance between emergence points was 413 micrometers.

FIG. 6 is divided into four quadrants by two lines, each being placed at an amplitude of 15000.

The upper-right quadrant corresponds to detected particle pairs composed of two α particles. The upper-left quadrant corresponds to detected particle pairs composed first of a β particle and then an α particle.

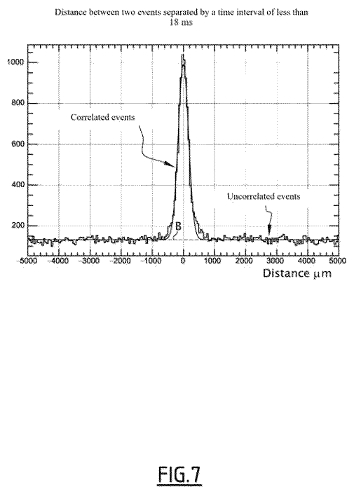

The FIGS. 7 to 9 illustrate the data collected, by means of autoradiography, of a uranium-ore sample containing ²³⁵U and ²³⁸U.

Autoradiography was performed with the detector 2 in a mode.

FIG. 7 represents the distribution of distance between the respective emergence points of the α particle pairs that are emitted nearly simultaneously.

In other words, only particle pairs are considered in FIG. 7 such that:
The respective detection times of the first particle and the second particle are separated by a time interval less than 18 milliseconds, i.e., 10 half-lives of ²¹⁵Po;
The charge deposited by the first detected particle shows that this particle is of type α;
The charge deposited by the second detected particle shows that this second particle is of type α.

The chosen characteristics aim to identify the pairs corresponding to the decay, in the ²³⁵U chain, of ²¹⁹Rn, immediately followed by the decay of ²¹⁵Po.

In FIG. 7, the distance in micrometers between successive particles is on the abscissa, and the number of identified pairs is on the ordinate.

FIG. 7 shows that the distribution is strongly centered on a distance of 0 micrometers. The central peak corresponds to almost simultaneous a particle emissions, originating from the same point of the solid sample. These pairs can be associated with a high degree of probability to the decay of a ²¹⁹Rn followed by a ²¹⁵Po.

The pairs that are not located at the central peak correspond to almost simultaneous decays, but they originate from different points of the solid sample. These pairs cannot be associated with the successive decays of a ²¹⁹Rn and a ²¹⁵Po.

The pairs located under the central peak and under the baseline B correspond to simultaneous decay particles that originate from substantially the same emission point but not emitted by the sought isotopes. These pairs result from the random probability of the existence of coincident pairs spatially and temporally.

The peak can be substantially applied to a Gaussian distribution with a standard deviation at half-height of about 165.3 micrometers. For this embodiment example, it is therefore relevant to use as a pair spatial limit for sorting the detected particle pairs a value of 413 micrometers, corresponding substantially to 2.5 times the standard deviation of the Gaussian distribution. This makes it possible to eliminate the particle pairs detected simultaneously but clearly originating from different points of the radiological sample. This does not allow eliminating the particle pairs detected simultaneously and originating from the same emission point that result from the Poisson probability of pair creation.

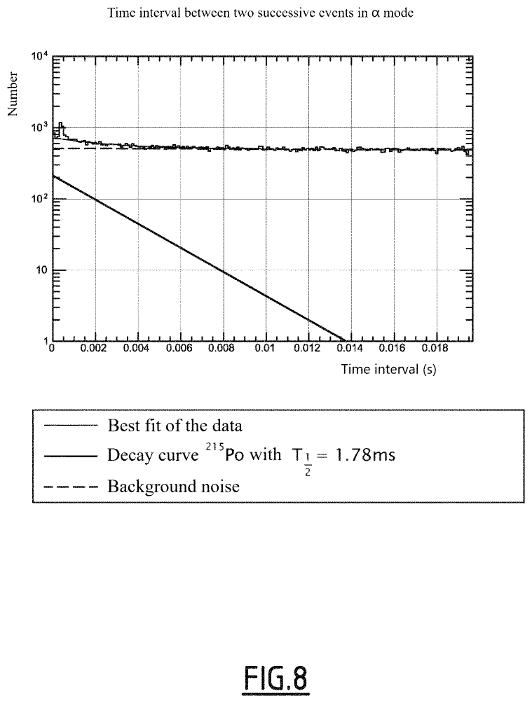

FIG. 8 represents the distribution of time intervals separating the respective detection times of the same particle pair. The same data is used as in FIG. 7.

Only particle pairs that meet the following criteria are considered for FIG. 8:
The charge deposited by the first detected particle corresponds to a particle of type α;
The charge deposited by the second detected particle corresponds to a particle of type α;
The first detected particle and the second detected particle are successive, the autoradiography system having detected no other particle between the first and second detected particles, and the interval between detection times is less than about 17.8 milliseconds.

However, no criterion is applied to the distance between the emergence points of the first and second detected particles.

In FIG. 8, the time interval is on the abscissa, and the number of particle pairs is on the ordinate.

FIG. 8 shows that the distribution is substantially uniform with a low-height bump between 0 and 0.5 milliseconds.

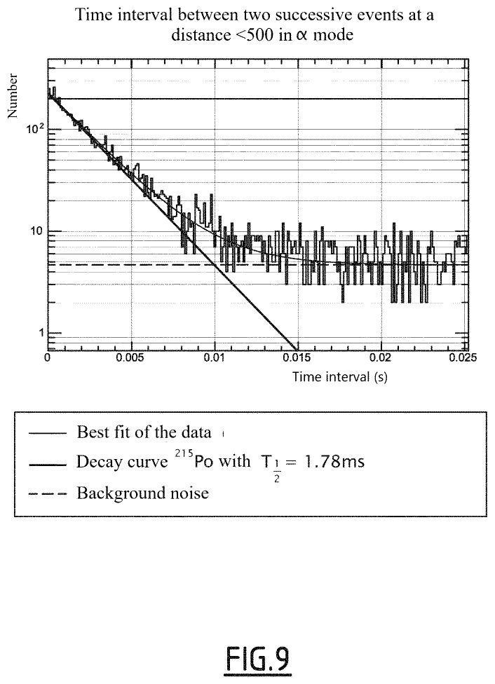

FIG. 9 is similar to FIG. 8, but only particle pairs that meet, in addition to the criteria for FIG. 8, a distance between emergence points less than 413 micrometers are retained.

FIG. 9 shows that the distribution has a maximum centered on the origin of times, then decreasing and tending toward the horizontal from 15 milliseconds. This distribution can be applied to an exponential decay law with a half-life of 1.78 milliseconds, corresponding to the half-life of ²¹⁵Po.

This exponential law has the equation:

$$C = {C}_{0} {e}^{- λ t}$$

C₀ being the number of doublets detected for t=0; and
λ being the half-life period of ²¹⁵Po.

The coefficient λ also corresponds to the slope at the origin of the curve.

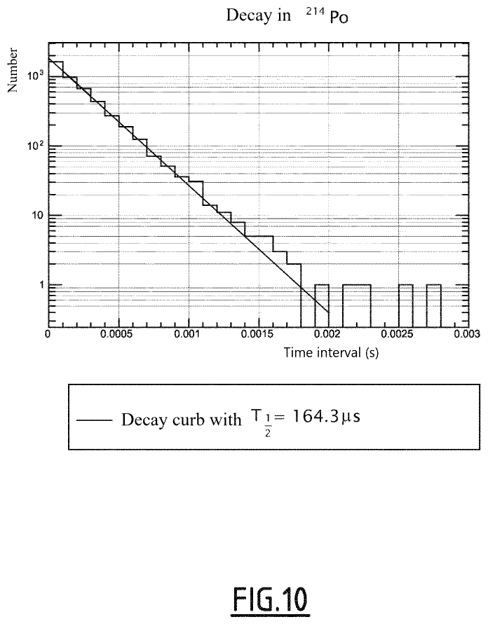

FIG. 10 illustrates the data collected, by means of autoradiography, of a uranium-ore sample containing ²³⁵U and ²³⁸U.

Autoradiography was performed with the detector 2 in the electron mode.

FIG. 10 is a curve similar to FIG. 9. The data is processed in order to detect the presence of ²¹⁴Bi and ²¹⁴Po, both of which belong to the radioactive decay chain of ²³⁸U.

FIG. 10 represents the distribution of detection-time intervals for particle pairs that meet the following criteria:
The charge emitted in the autoradiography system by the first detected particle corresponds to a particle of type β;
The charge emitted in the autoradiography system by the second detected particle corresponds to a particle of type α;
The distance between the respective emergence points of the two detected particles is less than 413 μm.

The distribution can be applied to an exponential decay with a half-life of 164.3 microseconds, corresponding to the half-life of ²¹⁴Po.

According to an advantageous variant, the step of analyzing the recorded data aims to detect not only the presence of the first and second radioactive isotopes but also the presence of a third radioactive isotope located in the decay chain immediately before the first radioactive isotope.

For example, the first isotope is ²¹⁹Rn, the second is ²¹⁵Po, and the third is ²²³Ra, as can be seen with reference to FIG. 1 on the decay chain of ²³⁵U.

The third isotope decays by the emission of a third particle of type α or type β with a third half-life period.

The data-analysis step comprises in this case a sub-step of searching, for each identified pair, for a third detected particle that meets the following criteria:
The detection time of the third detected particle is earlier than the detection time of the first detected particle and separated from it by a time interval that is less than a given triplet time limit;
The distance between the respective emergence points of the third detected particle and the first detected particle is less than a given triplet spatial limit;
The charge deposited by the third detected particle corresponding to the type of the third particle emitted by the third isotope during its decay.

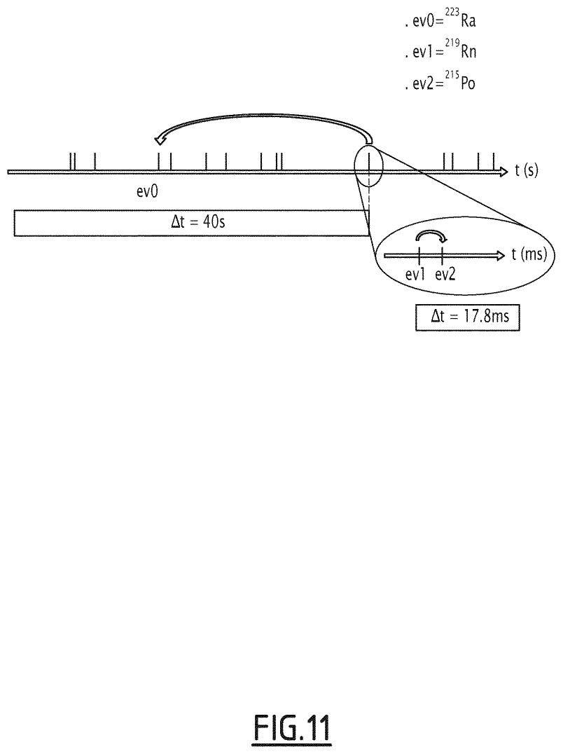

The situation is represented schematically in FIG. 11.

The given triplet time limit is determined in consideration of the half-life period of the first radioactive element, which, as shown in the example, is ²¹⁹Rn (the second isotope being ²¹⁵Po and the third ²²³Ra).

For example, said other time interval is less than or equal to 20 times the first half-life period, preferably equal to ten times the first half-life period.

The triplet spatial limit is typically chosen equal to the pair spatial limit used to search for detected particle pairs.

At the end of the search sub-step, the number of third detected particles is counted and possibly mapped according to the emergence point on the solid sample.

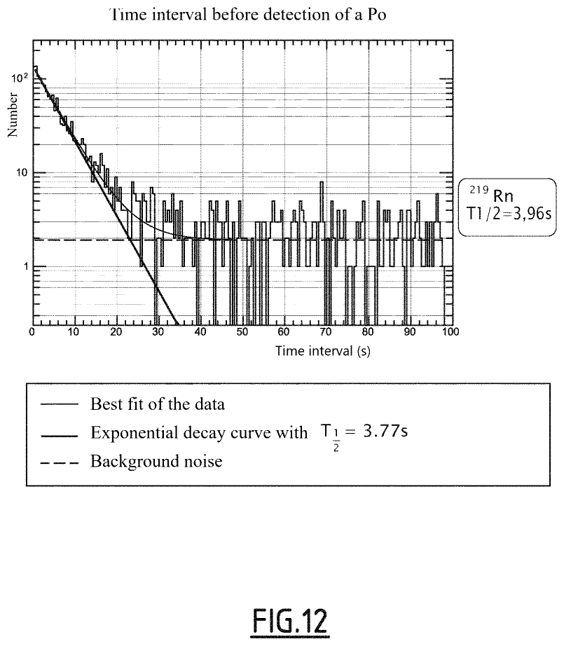

FIG. 12 illustrates the results obtained with the above embodiment variant.

The search sub-step was applied to the data used for the FIGS. 7 to 9.

It aims to identify the presence of three isotopes. The first isotope is ²¹⁹Rn, the second isotope is ²¹⁵Po, and the third isotope is ²²³Ra.

The criteria used to identify the pairs from the first and second radioisotope are the same as those used for the FIGS. 7 to 9: time interval of 18 milliseconds, a pair spatial limit of 413 micrometers, the first detected particle of type α and the second detected particle of type α.

For the search sub-step, the triplet spatial limit is 413 micrometers.

The half-life period of ²¹⁹Rn is 3.96 seconds, the triplet time limit being set at 40 seconds.

The second detected particle is of type α, and the third detected particle is of type α.

FIG. 12 is a view similar to that of FIG. 8.

FIG. 12 shows the distribution of time intervals between the detection time of the third particle, i.e., the particle emitted by ²²³Ra, and the detection time of the first particle, i.e., the particle emitted by ²¹⁹Rn.

In this figure the abscissa corresponds to the time interval expressed in seconds, and the ordinate corresponds to the number of detected particle triplets found in the search sub-step.

The distribution can be applied to an exponential curve with the equation:

$$C = {C}_{0} {e}^{- λ t}$$

C₀ being the number of triplets for t=0 and
λ being the half-life period of ²¹⁹Rn.

The coefficient λ also corresponds to the slope at the origin of the curve. The half-life period thus calculated is about 3.77 seconds, very close to the half-life of ²¹⁹Rn (3.96 seconds).

The characterization method can be applied, as described above, when the decay chain is that of ²³⁵U with the first isotope being ²¹⁹Rn and the second isotope being ²¹⁵Po.

It has also been described above an application to the case where the decay chain is that of ²³⁸U with the first isotope being ²¹⁴Bi and the second isotope being ²¹⁴Po.

Other applications are possible. The characterization method can be applied when the decay chain is that of ²³²Th, the first isotope being ²²⁰Rn and the second isotope being ²¹⁶Po. It can also be applied when the decay chain is that of ²³⁷Np, the first isotope being ²²¹Fr and the second isotope being ²¹⁷At.

For medical applications, several decay chains can be considered.

For example, the decay chain is that of ²²⁵Ac and the first isotope being ²²¹Fr and the second isotope being ²¹⁷At.

Alternatively, the decay chain is that of ²²³Ra, the first isotope being ²¹⁹Rn and the second isotope being ²¹⁵Po. The decay chain of ²²³Ra constitutes a part of the decay chain of ²³⁵U (see FIG. 1).

According to another variant, the decay chain is that of ²²⁷Th, the first isotope being ²¹⁹Rn and the second isotope being ²¹⁵Po. The decay chain of ²²⁷Th constitutes a part of the decay chain of ²³⁵U (see FIG. 1).

According to another variant, the decay chain is that of ²¹³Bi, the first isotope being ²¹³Bi and the second isotope being ²¹³Po.

Other decay chains can be considered.

The present disclosure also pertains to a characterization set of a solid sample likely to contain a radioactive element decaying through a decay chain by the emission of α and/or β particles.

This characterization set is particularly suitable for implementing the characterization method described above.

Conversely, the method is specially designed to be implemented by the characterization set described below.

The solid sample is of the above-described type, and the radioactive element is also of the above-described type.

The characterization set comprises an autoradiography system 1 of the solid sample comprising a detector 2 configured to detect the α and/or β particles emitted by the solid sample, and, for each detected α or β particle, record the following data: the detection time of the particle, the spatial coordinates of an emergence point of the particle and the charge deposited by the particle upon detection.

The autoradiography system 1 is of the above-described type with reference to FIG. 2. Typically, it is a device of the Beaquant type, marketed by the company Ai4R (Nantes).

The autoradiography system 1 comprises a digital processing unit 45 configured to record the above data, for example, a computer memory.

This unit 45 is digitally connected to the processing electronics 43 of the detector 2.

The data is structured as described above and represented in FIG. 3.

The characterization set further comprises a unit 47 for analyzing the recorded data, being configured to identify the presence of the first radioactive isotope and/or the second radioactive isotope in the solid sample.

The unit 47 for analyzing the recorded data is, for example, formed of a processor and a memory associated with the processor. Software is stored in the memory and, when executed by the processor, allows the detection of the presence of the first and/or second radioactive isotope(s) in the solid sample.

Alternatively, the analysis unit 47 is implemented in the form of a programmable logic component such as FPGAs (Field-Programmable Gate Array) or even in the form of a dedicated integrated circuit such as an ASIC (Application-Specific Integrated Circuit).

The data analysis unit 47 is configured to:
identify the pairs that comprise a first detected particle and a second detected particle later than the first particle, said pair meeting the following criteria: respective detection times of the first detected particle and the second detected particle separated by a time interval that is less than a given pair's time limit; the distance between the respective emergence points of the first detected particle and the second detected particle less than a given pair spatial limit; and the charge deposited by the first detected particle corresponding to the type of the first particle emitted by the first isotope during its decay; and the charge deposited by the second detected particle corresponding to the type of second particle emitted by the second isotope during its decay;
count the number of identified pairs.

The data analysis unit 47 is configured to identify the pairs and count the number of identified pairs as described concerning the characterization method.

In particular, the data analysis unit 47 is configured to map, in the radiological sample, the spatial coordinates of the emergence points of the first and second detected particles of the identified pairs.

Alternatively, the recorded data analysis unit is configured to identify the presence in the solid sample, not only of the first isotope and the second isotope but also of a third radioactive isotope, placed in the decay chain immediately before the first radioactive isotope.

The data analysis unit 47 is then configured to search, for each identified pair, for a third detected particle that meets the following criteria:
The detection time of the third detected particle is earlier than the detection time of the first detected particle and separated from it by a time interval that is less than a given triplet time limit;
The distance between the respective emergence points of the third detected particle and the first detected particle less than a given triplet spatial limit;
The charge deposited by the third detected particle corresponding to the type of the third particle emitted by the third isotope during its decay.

The data analysis unit 47 is configured to perform this search as described above concerning the characterization method.

The characterization set is configured for the same applications as the characterization method.

The method and characterization set have multiple advantages.

The fact of using, to constitute the detected particle pairs, only particles whose detection times are immediately consecutive allows simplifying the step of identifying the pairs.

The fact of searching in the solid sample as the second radioactive isotope the one having the smallest of the half-life periods in the decay chain greater than a dead time of the detector, allows increasing the precision of the characterization.

The fact of searching in the sample for pairs of particles emitted at the same time (close times) and in the same place (close positions) allows discarding random pairs emitted at the same time but not in the same place.

The fact that the data-analysis step comprises a sub-step of mapping in the radiological sample the spatial coordinates of the emergence points of the first and second detected particles of the identified pairs, allows obtaining a mapping of the radioactive isotopes in the solid sample.

This mapping can then be superimposed on another mapping, showing the chemical composition of the solid sample. This provides indications on the chemical form of the radioactive isotopes.

The counting step allows quantifying the amount of the first and second radioactive isotopes present in the solid sample. Since the solid sample is considered to be at secular equilibrium, this allows determining the concentration of other radioactive isotopes present in the decay chain.

In the case of residues or waste from mines, particularly uranium, the detection of the pair ²¹⁴Bi, ²¹⁴Po allows tracing back to the amount of ²²⁶Ra present in these residues or waste. Since ²²⁶Ra has a half-life of 1,602 years, this element is particularly constraining for the management of mining residues or waste. The quantification and localization of ²²⁶Ra in these wastes is therefore particularly important for choosing an appropriate management mode.

The precise autoradiography of the radioactive elements ²¹⁹Rn and ²¹⁵Po allows mapping radon. Radon is a radioactive gas that tends to escape from the sample during its formation. This gas is created by the decay of radium. The system allows quantifying the escape of radon by counting the pairs ²¹⁹Rn/²¹⁵Po located outside the solid sample.

The method and characterization set can have multiple variants.

According to FIG. 11, the third radioactive isotope sought is located immediately before the first radioactive isotope. According to an advantageous variant, if the third radioactive isotope sought was located immediately after the second, the analysis step described by FIG. 11 would not be appropriate. Nevertheless, the search for a third radionuclide resulting from the decay of the second would obey substantially the same principles.

Autoradiography can be performed not in equipment of the above-described type but in scintillation equipment.

What is claimed is:

1-10. (canceled)

11. A characterization method for characterizing whether a solid sample contains a radioactive element decaying through a decay chain by the emission of α and/or β particles, the decay chain passing successively through a first radioactive isotope and then a second radioactive isotope, the first isotope decaying by the emission of a first particle of type α or type β with a first half-life period, the second isotope decaying by emission of a second particle of type α or type β with a second half-life period shorter than the first half-life period, the method comprising the following steps:
performing autoradiography of the solid sample with detection using a detector of the α and/or β particles emitted by the solid sample and, for each detected α or β particle, recording the following data:
a detection time of the particle,
spatial coordinates of an emergence point of the particle, and
a charge deposited by the particle upon detection; and
analyzing the recorded data to detect a presence of the first radioactive isotope and/or second radioactive isotope in the solid sample, the analyzing of the recorded data comprising the following sub-steps:
identifying pairs comprising a first detected particle and a second detected particle later than the first, said pair meeting the following criteria:
respective detection times of the first detected particle and the second detected particle separated by a time interval that is less than a given pair's time limit;
a distance between the respective emergence points of the first detected particle and the second detected particle less than a given pair spatial limit;
a charge deposited by the first detected particle corresponding to the type of the first particle emitted by the first isotope during its decay; and
a charge deposited by the second detected particle corresponding to the type of second particle emitted by the second isotope during its decay; and
counting a number of the identified pairs.

12. The characterization method according to claim 11, wherein the respective detection times of the first and second detected particles of the same pair are immediately consecutive with no other particle being detected between the first and second detected particles.

13. The characterization method according to claim 11, wherein the decay chain passes successively through a plurality of radioactive isotopes, each decaying by emission of a particle of type α or type β with a half-life period, the second half-life period being a smallest of a group of half-life periods in the decay chain greater than a dead time of the detector.

14. The characterization method according to claim 11, wherein said time interval is less than 20 times the second half-life period.

15. The characterization method according to claim 11, wherein the step of analyzing the recorded data further comprises a sub-step of mapping in the solid sample the spatial coordinates of the emergence points of the first and second detected particles of the identified pairs.

16. The characterization method according to claim 11, wherein the decay chain passes through a third radioactive isotope immediately before the first radioactive isotope, the third isotope decaying by emission of a third particle of type α or type β,
the step of analyzing the recorded data comprising a sub-step of searching, for each identified pair, for a third detected particle that meets the following criteria:
a detection time of the third detected particle is earlier than the detection time of the first detected particle and separated from first detected particle by a time interval that is less than a given triplet time limit;
a distance between the respective emergence points of the third detected particle and the first detected particle less than a given triplet spatial limit; and
a charge deposited by the third detected particle corresponding to the type of the third particle emitted by the third isotope during its decay.

17. The characterization method according to claim 11, wherein the decay chain is chosen from:
that of ²³⁵U, the first isotope being ²¹⁹Rn and the second being ²¹⁵Po; or
that of ²³⁸U, the first isotope being ²¹⁴Bi and the second being ²¹⁴Po; or
that of ²³²Th, the first isotope being ²²⁰Rn and the second being ²¹⁶Po; or
that of ²³⁷Np, the first isotope being ²²¹Fr and the second being ²¹⁷At

18. A characterization set of a solid sample likely to contain a radioactive element decaying through a decay chain by an emission of α and/or β particles, the decay chain passing successively through a first radioactive isotope and then a second radioactive isotope, the first isotope decaying by the emission of a first particle of type α or type β with a first half-life period, the second isotope decaying by the emission of a second particle of type α or type β with a second half-life period shorter than the first half-life period, the characterization set comprising:
an autoradiography system of the solid sample comprising a detector configured to detect the α and/or β particles emitted by the solid sample, and, for each detected α or β particle, record the following data:
detection time of the particle,
spatial coordinates of an emergence point of the particle, and
charge deposited by the particle upon detection;
a unit for analyzing the recorded data, being configured to identify a presence of the first radioactive isotope and/or second radioactive isotope in the solid sample, the data analysis unit being configured to:
identify the pairs that comprise a first detected particle and a second detected particle detected later than the first, said pair meeting the following criteria:
respective detection times of the first detected particle and the second detected particle separated by a time interval that is less than a given pair's time limit;
a distance between the respective emergence points of the first detected particle and the second detected particle less than a given pair spatial limit;
a charge deposited by the first detected particle corresponding to the type of the first particle emitted by the first isotope during its decay; and
a charge deposited by the second detected particle corresponding to the type of second particle emitted by the second isotope during its decay;
counting a number of the identified pairs.

19. The characterization set according to claim 18, wherein the data analysis unit is configured to map, in the solid sample, the spatial coordinates of the emergence points of the first and second detected particles of the identified pairs.

20. The characterization set according to claim 18, wherein the decay chain passes through a third radioactive isotope immediately before the first radioactive isotope, the third isotope decaying by the emission of a third particle of type α or type β,
the data analysis unit being configured to search, for each identified pair, for a third detected particle that meets the following criteria:
a detection time of the third detected particle earlier than the detection time of the first detected particle and separated from it by a time interval that is less than a given triplet time limit;
a distance between the respective emergence points of the third detected particle and the first detected particle less than a given triplet spatial limit;
a charge deposited by the third detected particle corresponding to the type of the third particle emitted by the third isotope during its decay.
